(19) United States
(12) Patent Application Publication
(10) Pub. No.: US 2015/0270640 A1
(43) Pub. Date: Sep. 24, 2015

(54) TRAILER WIRING CONNECTOR

(71) Applicants: Donald Thomas, Columbiana, OH (US); Christian Barcey, Canfield, OH (US); Khoa Le, Garden Grove, CA (US)

(72) Inventors: Donald Thomas, Columbiana, OH (US); Christian Barcey, Canfield, OH (US); Khoa Le, Garden Grove, CA (US)

(21) Appl. No.: 14/662,885

(22) Filed: Mar. 19, 2015

Related U.S. Application Data
(60) Provisional application No. 61/955,341, filed on Mar. 19, 2014.

(51) Int. Cl. H01R 13/623; H01R 13/52

(52) U.S. Cl. CPC H01R 13/623; H01R 13/5205

(57) ABSTRACT

A trailer wiring connector to provide mating to a trailer-side wiring harness. The trailer wiring connector includes a plug and a freely rotatable nut. The plug is configured to electrically communicate with electrical systems of a trailer. The freely rotatable nut is movably surrounding the plug and configured to mate with a trailer wiring connector assembly. At least two projections are disposed on the plug and preventing the freely rotatable nut from being removed.

### CROSS-REFERENCE TO RELATED APPLICATION

This application claims the benefit of and priority to U.S. Provisional Patent Application Ser. No. 61/703,303, entitled TRAILER WIRING CONNECTOR and filed Mar. 19, 2014, the entire disclosure of which is incorporated herein by reference, to the extent that it is not conflicting with the application.

### BACKGROUND

Trailers have many uses for commercial and personal purposes. A trailer is typically connected to a vehicle which pulls the trailer by a mechanical connection, so that the vehicle may physically pull the trailer, and by an electrical connection, so that the electrical system of the vehicle may power the trailer. A typical trailer includes lighting capabilities on a rear frame, which may include various lighting features, such as for example, reverse lighting, brake lighting, and turn signal lighting.

### SUMMARY

The present application describes various methods and apparatus for a trailer wiring connector to provide mating to a trailer-side wiring harness.

In an exemplary embodiment of the invention, the trailer wiring connector includes a plug configured to electrically communicate with electrical systems of a trailer, a freely rotatable nut movably surrounding the plug and configured to mate with a trailer wiring connector assembly, and at least two projections disposed on the plug and preventing the freely rotatable nut from being removed. The connector may offer water and dirt resistant features when in an installed condition and when in a stored condition.

### BRIEF DESCRIPTION OF THE DRAWINGS

Features and advantages of the general inventive concepts will become apparent from the following detailed description made with reference to the accompanying drawings.

FIG. 1 is a front left side perspective view of a trailer wiring connector;

FIG. 2 is a front right side perspective view of the trailer wiring connector of FIG. 1;

FIG. 3 is a front perspective view of a trailer wiring connector assembly;

FIG. 4 is a rear perspective view of the assembly of FIG. 3;

FIG. 5 is a front perspective view of a trailer wiring connector assembly;

FIG. 6 is a front enlarged perspective view of a connector of the assembly of FIG. 5; and

FIG. 7 is a rear perspective view of the assembly of FIG. 5.

### DETAILED DESCRIPTION

This Detailed Description merely describes exemplary embodiments in accordance with the general inventive concepts and is not intended to limit the scope of the invention in any way. Indeed, the invention as described in the specification is broader than and unlimited by the exemplary embodiments set forth herein, and the terms used herein have their full ordinary meaning.

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts.

The present invention is directed to a heavy duty trailer wiring connector. The invention includes features that are not included in conventional trailer wiring connectors. The invention includes, but is not limited to, 7-way round, 4-way flat, and 5-way flat trailer and car-side connectors.

The present invention is directed to a trailer-side wiring harness. An exemplary embodiment for a trailer wiring connector includes a plug and a freely rotatable nut. The plug is configured to electrically communicate with electrical systems of a trailer. The freely rotatable nut is movably surrounding the plug and configured to mate with a trailer wiring connector assembly. At least two projections are disposed on the plug and preventing the freely rotatable nut from being removed.

The inventive connector has a robust housing design. The mating between the car-side connector and the trailer-side connector is a heavy duty screw-on connection. The car-side connectors have built in threads that mate with a free spinning nut style cap on the mating trailer side. This screw-on connection improves on conventional wiring connectors by improving the security of the connection. For example, the secure connection ensures the connectors stay in position when experiencing the harsh vibrations typical of towing.

When used as a system, the heavy duty trailer wiring connector family provides a water-resistant connection. This water-resistant connection includes several features. The car-side heavy duty wiring connector mates with an original equipment manufacturer (OEM) sealed connector for a sealed connection to the car-side wiring harness. The car-side heavy duty trailer wiring connector features a screw-on connection to the trailer-side heavy duty trailer wiring connector which includes a rubber or other like material grommet. When tightened, the screw-on connection compresses against this gasket and creates a water-resistant seal to the connector pins. Further, the trailer-side heavy duty trailer wiring connector includes a screw-on compression fitting for mating to the trailer-side wiring harness. This compression fitting includes a twist-on cap that when installed forces a rubber or like material grommet into the heavy duty trailer wiring connector. The grommet creates a pressure seal water-resistant connection to the trailer side wiring.

The heavy duty trailer wiring connector also offers improved features in a stored condition. For example, the connector is water and dust resistant when not in use. The car-side heavy duty trailer wiring connector includes a screw-on cap to be used to seal the connector when in a stored condition. This screw-on cap includes a rubber or other like material grommet. When tightened, the screw-on connection compresses against this gasket and creates a water-resistant seal to the connector pins. Also, the heavy duty trailer wiring connector family includes a trailer mounting bracket for when not in use. The trailer side connector mates with this bracket. This arrangement is used to keep the trailer-side connector off the ground when not in use. This connection takes advantage of the screw-on nut style cap on the trailer side connector. When tightened the screw-on connection compresses the bracket against this gasket and creates a water-resistant seal to the connector pins.

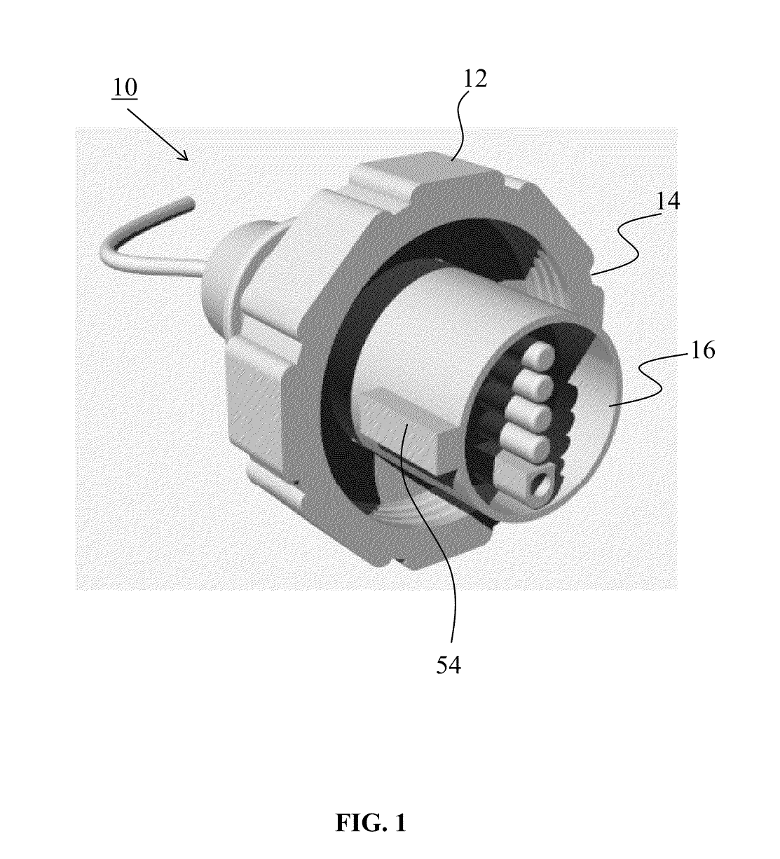

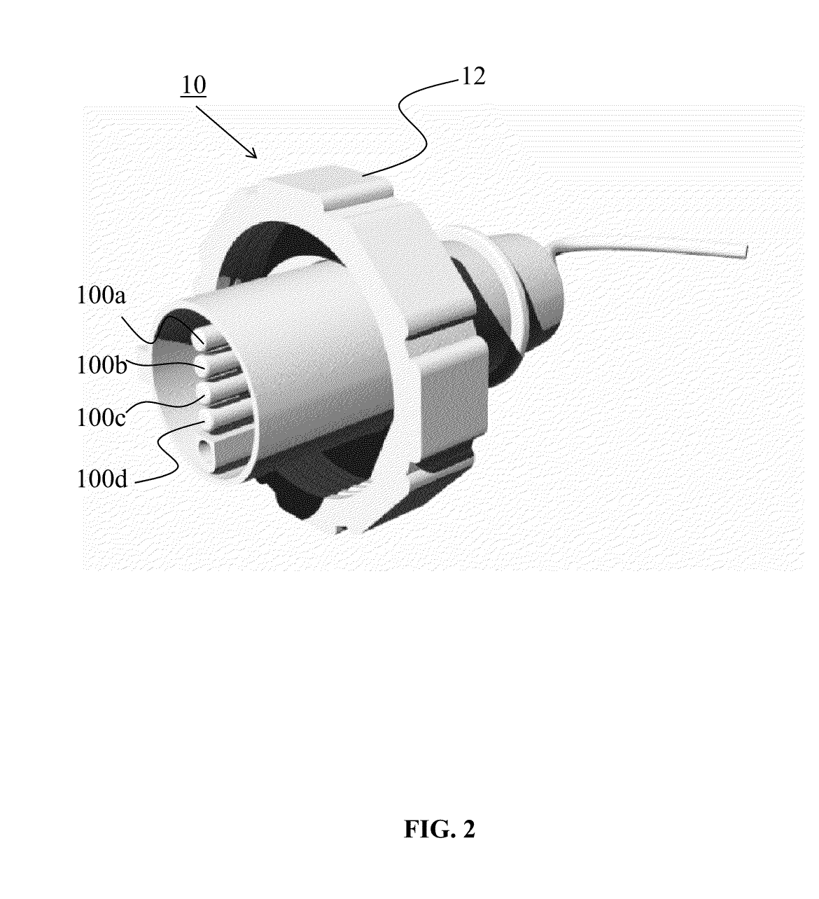

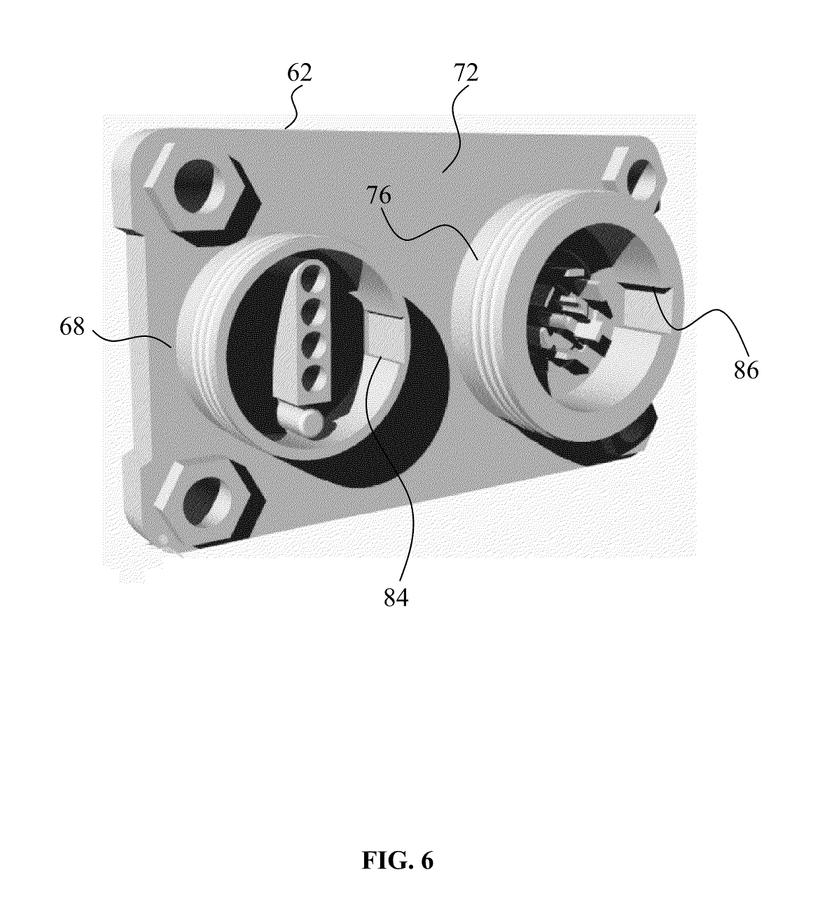

Referring now to the drawings, several exemplary embodiments of the invention will now be discussed. Several exemplary embodiments of the invention are illustrated and fully disclosed in FIGS. 1-7. The invention is not limited to the embodiments illustrated in FIGS. 1-7 and discussed in the specification.

FIG. 1 is a front left side perspective view of an exemplary trailer wiring connector 10. A front right side perspective view of the trailer wiring connector 10 is illustrated in FIG. 1. The connector includes a nut 12, a female threaded cavity 14, and a plug 16. The plug houses a set of prongs which at least in part define the connector type.

The connector includes projections disposed on the plug. The projections prevent the freely rotatable nut from being removed. Referring again to FIG. 1, the exemplary connector 100a, 100b, 100c, 100d. The same or similar projection set is illustrated in other plugs throughout the Figures.

In FIGS. 1-5, a radial projection 54 is illustrated on the outside surface of the plug. The projection 54 is inserted into a slot 54 in a male-threaded prone 52 to prevent rotational of the prone or the plate, relative to any part which is mating to either part.

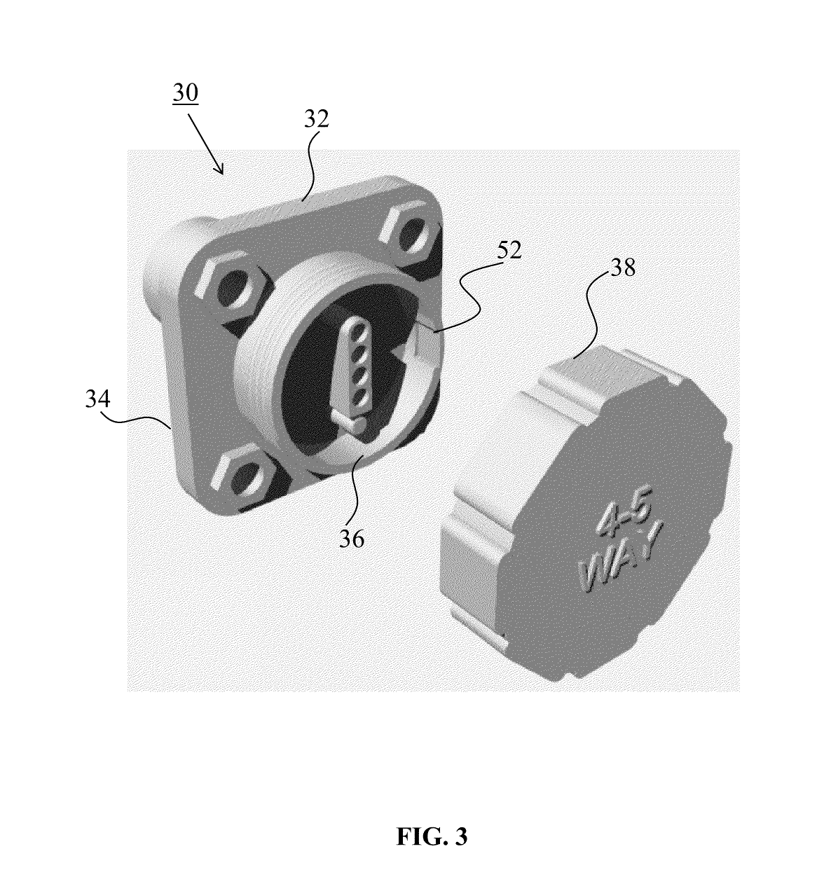

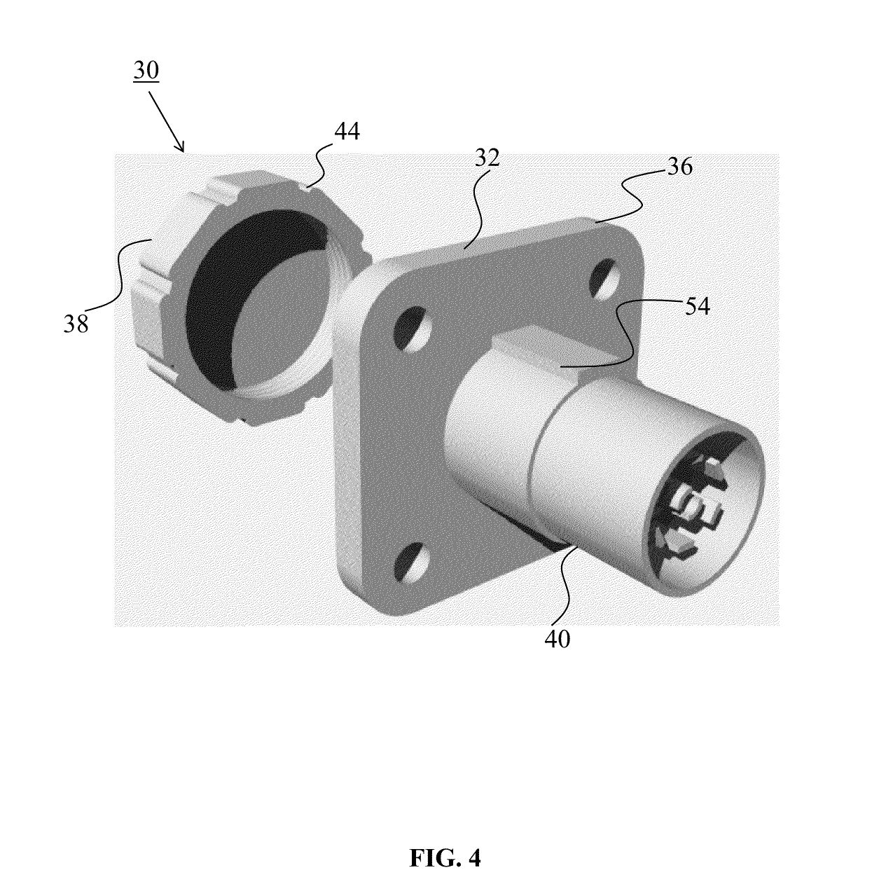

FIG. 3 is a front perspective view of a trailer wiring connector assembly 30. A rear perspective view of the assembly 30 of FIG. 4. The assembly include a connector 32 and a cap 38. The connector 32 includes a plate 36, the male-threaded prone 34, and a prone 40. The cap 38 includes a female-threaded cavity 44.

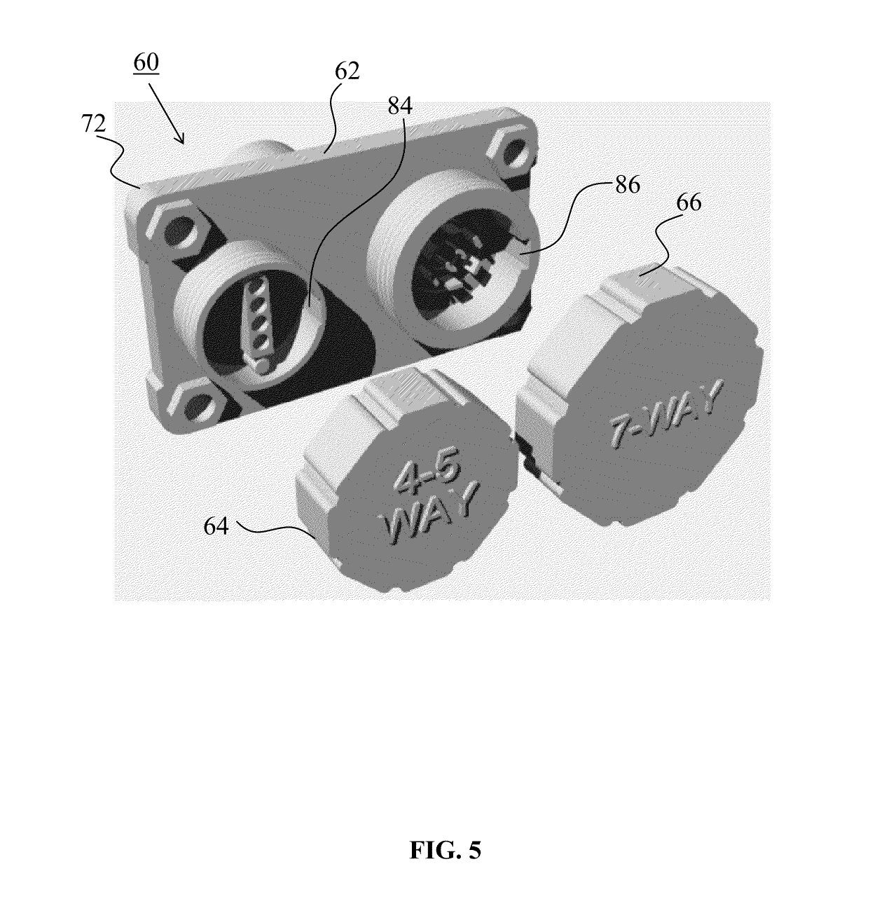

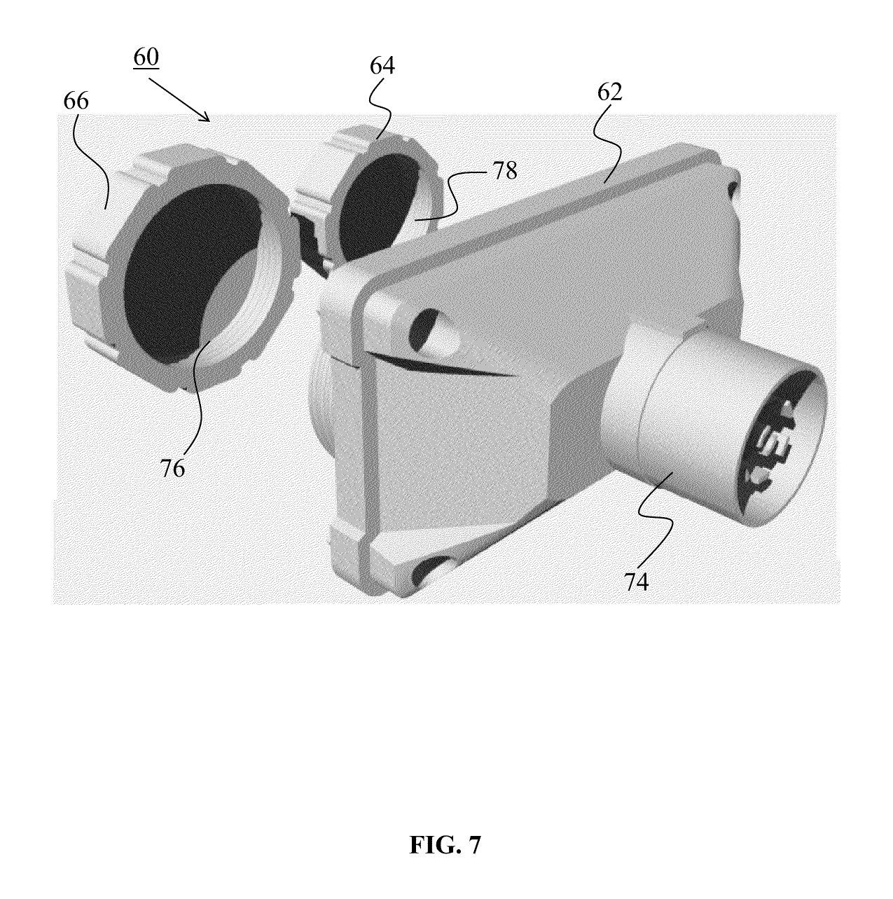

FIG. 5 is a front perspective view of a trailer wiring connector assembly 60. An enlarged view of a connector 62 of the assembly 60 is illustrated in FIG. 5. FIG. 7 is a rear perspective view of the assembly 60 of FIG. 5. The assembly 60 includes the connector 62, a first cap 64 and a second cap 66. The connector 62 includes a plate 72, a first male-threaded prong 68, a second male-threaded prong 70, and a third prong 74. The first cap 64 includes a female-threaded cavity 78. The second cap 66 includes a female-threaded cavity 76.

In FIGS. 5-7, a radial slot 84, 86 is illustrated on the inside surface of either prong 68 on the plate 72. The radial slot 84, 86 is to prevent rotational of the prone, relative to any part which is mating to either part.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasable or removably, connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

Further, while various inventive aspects, concepts and features of the general inventive concepts are described and illustrated herein in the context of various exemplary embodiments, these various aspects, concepts, and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts, and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some aspects, concepts, and features of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, concepts, and features may be expressly identified herein as being inventive or forming part of an invention, such identification is not intended to be exclusive, but rather there may be inventive aspects, concepts, and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A trailer wiring connector comprising:
a plug configured to electrically communicate with electrical systems of a trailer;
a freely rotatable nut movably surrounding the plug and configured to mate with a trailer wiring connector assembly; and
at least two projections disposed on the plug and preventing the freely rotatable nut from being removed.

2. The trailer wiring connector of claim 1, wherein the freely rotatable nut is female threaded.

3. The trailer wiring connector of claim 1, wherein the freely rotatable nut comprises a screw-on connection compress.

4. The trailer wiring connector of claim 1, wherein the freely rotatable nut comprises a rubber material grommet.

5. The trailer wiring connector of claim 1 further comprising a trailer mounting bracket.

6. A trailer wiring connector assembly comprising:
a plate mountable to a vehicle; and
at least one slot disposed on the plate and configured to mate with a trailer wiring connector;
wherein the slot is configured to electrically communicate with electrical systems of a car.

7. The trailer wiring connector assembly of claim 6, wherein the slot is male threaded.

8. The trailer wiring connector assembly of claim 6 further comprising a screw-on compression fitting disposed on the plate.

9. The trailer wiring connector assembly of claim 6 further comprising at least one cap, wherein the cap is configured to mate with the slot.

10. The trailer wiring connector assembly of claim 9, wherein the cap is female threaded.

11. The trailer wiring connector assembly of claim 10, wherein the cap comprises a rubber grommet.

12. A trailer wiring connector kit, comprising:
a trailer wiring connector comprising:
a plug configured to electrically communicate with electrical systems of a trailer;
a freely rotatable nut movably surrounding the plug; and
at least two projections disposed on the plug and preventing the freely rotatable nut from being removed; and
a trailer wiring connector assembly comprising:
a plate mountable to a vehicle; and
at least one slot disposed on the plate and configured to electrically communicate with electrical systems of a car;
wherein the freely rotatable nut is configured to mate with the slot.
